(19) United States
(12) Patent Application Publication
(10) Pub. No.: US 2023/0330915 A1
(43) Pub. Date: Oct. 19, 2023

(54) THERMOPLASTIC ARTICLES HAVING PRECISE MICRO-SCALE FEATURES AND LONG-RANGE MACRO-SCALE REPRODUCIBILITY

(71) Applicant: EDGE EMBOSSING, INC., Charlestown, MA (US)

(72) Inventors: Brian Alexander SMITH, Charlestown, MA (US); Andrew Evan KAMHOLZ, Charlestown, MA (US); Cameron John HARRIS, Charlestown, MA (US); Hootan FARHAT, Charlestown, MA (US); Jacob Thomas TRUEB, Charlestown, MA (US); Courtney Ann MCLOUD, Charlestown, MA (US); Meghan Ashley HEMOND, Charlestown, MA (US)

(21) Appl. No.: 18/008,402

(22) PCT Filed: Jun. 3, 2021
(86) PCT No.: PCT/US2021/035579

§ 371 Date: Dec. 5, 2022

Related U.S. Application Data
(60) Provisional application No. 63/034,103, filed on Jun. 3, 2020.

(51) Int. Cl. B29C 59/02; B29C 33/40; B29C 33/42

(52) U.S. Cl. CPC B29C 59/022; B29C 33/405; B29C 33/424; B29C 2059/023; B29K 2905/02; B29K 2883/00; B29K 2101/12

(57) ABSTRACT

A variety of thermoplastic parts are provided with precise micro-scale features and long-range macro-scale reproducibility. By combining the advantages of rigid tool molding and soft tooling into a hybrid tooling, complex and challenging microfeatures can be created in thermoplastic parts with remarkable positional accuracy and reproducibility. The parts described herein can demonstrate orders of magnitude smaller inter-part variations and order of magnitude smaller variations with respect to a master part as compared to conventional hard and soft tooling methods. In some aspects, a plurality of thermoplastic parts having precision micro-scale features and reproducible macro-scale dimensions are provided wherein the precision micro-scale features on each part comprise at least one challenging microfeature; and wherein a mean normalized displacement of the micro-scale features is about or less when measured between the parts in the plurality of thermoplastic parts.

### CROSS-REFERENCE TO RELATED APPLICATIONS

This application claims priority to, and the benefit of, co-pending U.S. Provisional Patent Application No. 63/034,103, filed Jun. 3, 2020, entitled “Thermoplastic Articles Having Precise Micro-Scale Features and Long-Range Macro-Scale Reproducibility,” the contents of which are incorporated herein in their entirety.

### TECHNICAL FIELD

The present disclosure generally relates to thermoplastic parts.

### BACKGROUND

Microfluidic devices have applications in a variety of fields, such as chemistry, medicine and biotechnology. The manufacturing of integrated microfluidic devices on a mass-production scale with relatively low costs can enable even greater commercial adoption of microfluidics. This is especially important for applications where disposable devices are used, e.g. for medical analysis. Disposable devices with microscale features are now commonplace among applications ranging from diagnostics to life sciences to point-of-care medical devices. The success of such devices as products depends, in part, on both the cost and quality of manufacture of the device. The technologies used in these devices often include one or more microscale structures (“microstructures”) such as microchannels, micropillars, microposts, microwells, nanowells, and numerous others well-known in relevant published literature. Many such devices conduct fluids for the purpose of performing assays, tests, measurements, or other observations on the fluid, which can consist of any biological fluid or other fluids prepared in a laboratory or clinical setting.

Numerous techniques have been explored to produce thermoplastic devices such as microfluidics and other devices with micro-scale features. However, the accurate production of thermoplastic components with challenging microfeatures and macro-scale reproducibility remains a challenge. These processes include 3D printing, CNC machining, rotational molding, vacuum forming, injection molding, extrusion, and blow molding.

3D printing can be used to build a part layer by layer until a complete physical part is formed. However, 3D printing has many limitations in the production of plastic parts, including a very limited selection of material choices, placing large restrictions of the chemical composition, rigidity, surface roughness, and physical properties such as density and absorbance, large tolerances in dimensional precision, making it difficult to achieve acceptable nominal dimensions to less than approximately 50-1000 micrometers precision, and an inability to produce microstructure features, such as microwells, micropillars, or microchannels, due to their very small size relative to the resolution of the 3D printer.

CNC machining starts from a solid material and uses various mills, lathes, and other computer-controlled subtractive processes to form the part. Machining processes have more part geometry restrictions than 3D printing. Machining processes require allowances for tool access and certain geometries, like curved internal channels and other challenging microfeatures, are difficult or impossible to produce with subtractive methods.

Rotational molding or roto-molding is a process by which a polymer is melted and formed onto the interior of a rotating mold. The method is used to produce larger hollow structures and does not provide for accurate or challenging microfeatures.

Vacuum forming can be used to produce things like product packaging but is limited to parts with relatively thin walls and simple geometries. Vacuum forming is not suitable for challenging microfeatures and does not provide a high degree of large-scale reproducibility.

Injection molding is one of the most common methods of manufacturing plastic components. Due to the high temperature and pressures involved, conventional injection molds are machined from metals like hardened steel. This creates limitations in the ability to demold certain challenging microfeatures such as low or negative draft angles, high aspects ratios, or vertical walls with textured surfaces. Micro-molding can be used to produce smaller parts and with micron-scale accuracies, but suffers from the same limitations as conventional injection molding so is not able to produce certain challenging microfeatures.

Soft tool molding is similar to injection molding but utilizes soft molds made of materials such as silicone or other rubber molds. Soft tooling has the advantage of ease of demolding, but at the sacrifice of the long-range macroscale reproducibility and positional tolerance or reproducibility. This is because the soft tooling, as compared to the hard tooling used in conventional injection molding, results in deformation of the mold during part forming.

Extrusion molding forms parts by pushing a molten plastic through a die that creates the desired shape. Extrusion molding is limited to simple parts that have continuous profiles, such as T-sections, I-sections, L-sections, U-sections, and square or circular sections.

Blow molding is used to create hollow plastic parts by inflating a heated plastic tube inside a mold until it forms into the mold shape. Blow molding is used to manufacture items like plastic bottles, but is limited to simple geometries and overall lesser precision than micro-scale injection molding.

Thus, there remains a need for improved thermoplastic articles and methods for forming thermoplastic articles that overcome the aforementioned deficiencies.

### SUMMARY

In one aspect, a plurality of thermoplastic parts include precision micro-scale features and reproducible macro-scale dimensions, where the precision micro-scale features on each part include at least one challenging microfeature, and where a mean normalized displacement of the precision micro-scale features is about 0.1% or less when measured between the parts in the plurality of thermoplastic parts.

In another aspect, a plurality of thermoplastic parts include precision micro-scale features and reproducible macro-scale dimensions, where the precision micro-scale features on each part include at least one challenging microfeature, and where a maximum normalized displacement of the precision micro-scale features is about 0.1% or less when measured between the parts in the plurality of thermoplastic parts.

In yet another aspect, a plurality of thermoplastic parts include precision micro-scale features and reproducible macro-scale dimensions, where the precision micro-scale features on each part include at least one challenging microfeature, and where a maximum displacement between the precision micro-scale features is about 10 μm or less when measured between the parts in the plurality of thermoplastic parts.

In yet another aspect, a plurality of thermoplastic parts include precision micro-scale features and reproducible macro-scale dimensions, where the precision micro-scale features on each part include at least one challenging microfeature, and where a mean displacement between the precision micro-scale features is about 10 μm or less when measured between the parts in the plurality of thermoplastic parts.

In yet another aspect, a thermoplastic part includes precision micro-scale features and reproducible macro-scale dimensions, where the precision micro-scale features comprise at least one challenging microfeature, and where a mean normalized contribution to the non-isotropic displacement between the precision micro-scale features is about 0.1% or less when measured between the thermoplastic part and an idealized master part.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1A is a top view of a plurality of a first exemplary challenging microfeature according to various aspects of the disclosure. FIG. 1B is a cross-sectional view along 1-1 in FIG. 1A.

FIG. 2A is a top view of a plurality of a second exemplary challenging microfeature according to various aspects of the disclosure. FIG. 2B is a cross-sectional view along 2-2 in FIG. 2A.

FIG. 3 is a top view showing exemplary cross section profiles that can be created in challenging microfeatures such as pillars and wells according to various aspects described herein.

FIG. 4 is a cross-sectional view of microfeatures having a positive draft angle (top), vertical sidewalls or zero draft angle (middle), and negative draft angles (bottom).

FIG. 5A is a top view of a plurality of a third exemplary challenging microfeature according to various aspects of the disclosure. FIG. 5B is a cross-sectional view along 5-5 in FIG. 5A.

FIG. 6A is a top view of a plurality of a fourth exemplary challenging microfeature according to various aspects of the disclosure. FIG. 6B is a cross-sectional view along 6-6 in FIG. 6A.

FIG. 7A is a top view of an exemplary part according to various aspects of the disclosure and including multiple challenging microfeatures. FIG. 7B is a cross-sectional view along 7-7 in FIG. 7A. FIG. 7C is a close-up view of the circled region in FIG. 7A.

FIG. 8A is a perspective view of a second exemplary part according to various aspects of the disclosure and including multiple challenging microfeatures. FIG. 8B is a top view of the second exemplary part. FIG. 8C is a cross-sectional view along 8-8 in FIG. 8B.

### DETAILED DESCRIPTION

Thermoplastic parts are provided having precision micro-scale features, even for challenging microfeatures, and long-range macro-scale reproducibility. The parts presented are incapable of being produced with conventional methods of plastic manufacturing and therefore extend the applicability and advantages of thermoplastic parts to even more applications. The parts are capable of even more complex geometries and structures than previously made while maintaining a high level of positional accuracy and reproducibility.

In some aspects, a plurality of thermoplastic parts are provided having precision micro-scale features and reproducible macro-scale dimensions; wherein the precision micro-scale features on each part comprise at least one challenging microfeature; and wherein a mean normalized displacement of the micro-scale features is about 0.1% or less when measured between the parts in the plurality of thermoplastic parts.

In some aspects, a plurality of thermoplastic parts are provided having precision micro-scale features and reproducible macro-scale dimensions; wherein the precision micro-scale features on each part comprise at least one challenging microfeature; and wherein a maximum normalized displacement of the micro-scale features is about 0.1% or less when measured between the parts in the plurality of thermoplastic parts.

In some aspects, a plurality of thermoplastic parts are provided having precision micro-scale features and reproducible macro-scale dimensions; wherein the precision micro-scale features on each part comprise at least one challenging microfeature; and wherein a maximum displacement between the micro-scale features is about 10 μm or less when measured between the parts in the plurality of thermoplastic parts.

In some aspects, a plurality of thermoplastic parts are provided having precision micro-scale features and reproducible macro-scale dimensions; wherein the precision micro-scale features on each part comprise at least one challenging microfeature; and wherein a mean displacement between the micro-scale features is about 10 μm or less when measured between the parts in the plurality of thermoplastic parts.

Before the present disclosure is described in greater detail, it is to be understood that this disclosure is not limited to particular aspects described, and as such may, of course, vary. It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 kN/m³; or a unit disclosed 100° F. is intended to mean an equivalent dimension of 37.8° C.; and the like) as understood by a person of ordinary skill in the art.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The “draft angle”, as the term is used herein, is an angle defined in terms of the mold or feature surfaces and a theoretical central axis along the direction of pull removal. In conventional molding, a positive draft angle is typically designed into all vertical walls to make ejection of the part from the mold easier. A draft angle is said to be a “positive draft angle” when the walls of the mold or feature slope away in the direction of pull from a theoretical central axis of the mold or feature. A draft angle is said to be a “negative draft angle” when the walls of the mold or feature slope inward in the direction of pull from a theoretical central axis of the mold or feature. A featured surface can include both features having a positive draft angle and features having a negative draft angle. A “non-negative draft angle” refers to a mold or feature having a zero draft angle or a positive draft angle.

A feature is said to have or alternatively to be an “undercut,” as the term is used herein, when one or more surfaces not visible with a direct line-of-sight when looking at the part from any possible angle, i.e. if there exists no angle from which at least one surface of the feature can be seen without other portions of the part interfering with the line-of-sight. An undercut can prevent the part from being ejected from a straight-pull mold without a portion of the mold damaging the part. The simplest example of an undercut feature on a part would be a through-hole aligned perpendicular to the direction of part ejection.

The terms “micro-scale feature,” as used herein, refers to a feature having one or more dimensions of about 1,000 micrometers or less and generally having dimensions larger than about 10 nanometers, 100 nanometers, or larger. In some instances, micro-scale features have a largest dimension of about 10 micrometers or about 50 micrometers to about 100 micrometers or about 250 micrometers.

The term “macro-scale” as used herein, refers to the overall dimensional features of a thermoplastic component which are typically dimensions of 1 millimeter or more, more precisely dimensions from about 1 millimeter, 5 millimeters, or 10 millimeters and up to about 20 millimeters, 100 millimeters, 500 millimeters, or even 1,000 millimeters.

The term “precision micro-scale features,” as used herein, refers to a micro-scale feature having an exceedingly small root mean square (RMS) deviation in micro-scale feature sizes as measured over multiple thermoplastic components. In some aspects, a precision micro-scale feature has RMS deviations of about 10 micrometers, about 1 micrometer, or less. In some aspects, a precision micro-scale feature has RMS deviations of about 10%, about 5%, about 1%, about 0.1% or less.

The term “reproducible macro-scale dimensions” refers to the repeatability of macro-scale dimensions between thermoplastic components as measured over multiple thermoplastic components. In some aspects, a macro-scale dimension is said to be reproducible when a root mean square (RMS) deviation of all or substantially all of the macro-scale dimensions is within a tolerance of 1%, 0.1%, 0.01%, 0.001%, 0.0001%, or less.

The term “rigid,” as used herein, refers to a material or component that can withstand bending or deformation of shape when exposed to typical pressures used in embossing and injection molding, e.g. having a modulus of rigidity of at least 10 GPa, 20 GPa, 25 GPa, 30 GPa or more

The terms “challenging microfeature” and “challenging micro-scale feature” as used interchangeably herein, refer generally to micro-scale features that are not capable of being demolded from a rigid mold without damaging one or both of the mold and the micro-scale feature. In conventional injection molding with a rigid mold, the parts must be designed with certain limitations otherwise the demolding process can result in damage or deformation to the part or the mold. Therefore, for conventional injection molding, the parts are designed to have draft angles to facilitate easier demolding. The stiffness of the thermoplastic material and the overall design and density of the features on the part also impact the ability to demold parts without damage or deformation. Vertical walls having features or texture can also increase friction between the part and mold necessitating larger draft angles. Examples of challenging microfeatures include a recess or protrusion with both (i) at least one lateral dimension of about 300 μm, about 250 μm, about 200 μm, or less and (ii) any one or more of the following: an aspect ratio (height:width) of at least 2:1, at least 3:1, or at least 4:1 and up to about 10:1, about 20:1, about 40:1, or about 50:1; at least one vertical wall having a draft angle of about 2°, about 1°, about 0° or less, including negative draft angles down to about −1°, −2°, or −5°; at least one undercut; at least one textured vertical surface having a texture depth of at least 0.01 μm, at least 0.1 μm, at least 0.5 μm, at least 1 μm, at least 2.5 μm, at least 10 μm, or at least 20 μm.

The term “vertical wall,” as used herein, refers to a wall of a micro-scale or macro-scale feature that is substantially perpendicular to the outer surface(s) of the part to which it connects, e.g. it meets the outer part surface at an angle of at least 45 degrees, at least 75 degrees, or at least 90 degrees. A vertical wall can be substantially aligned with the direction of pull removal.

The term “lateral dimension,” as used herein, refers to a dimension that is substantially parallel to the outer surface of the part on which the dimension is being measured, with the line that defines this dimension being at an angle at most 45 degrees from the plane that defines the outer surface, and typically at an angle of at most 15 degrees. A lateral dimension can be perpendicular to the direction of pull removal.

Thermoplastic Parts and Other Articles of Manufacture

A variety of thermoplastic parts and articles of manufacture are described herein having challenging microfeatures. The parts can be produced, not only with challenging microfeatures, but also with reproducible macro-scale dimensional accuracy. The parts and methods of making the parts expand the applicability of thermoplastic parts (and the associated benefits of costs, ease of scaling and manufacturing, etc.) to complex geometric structures not previously available using conventional methods.

The thermoplastic parts and articles of manufacture can be produced with exceptional tolerance to a master structure. The term “master structure” as used herein refers to a replication template, typically manufactured on a metallic substrate. The features of the master mold are fabricated using the UV-LIGA and other microfabrication processes. The microstructures created on the master mold may be of the same material as the master mold substrate e.g. Nickel microstructures on a Nickel substrate or may be a dissimilar material e.g. photoresist on a Silicon surface. The master structure can also refer to an idealized master part or master structure, i.e. the desired or intended geometry of the part.

In some aspects, a thermoplastic part or article of manufacture is provided having precision micro-scale features and reproducible macro-scale dimensions; wherein the precision micro-scale features comprise at least one challenging microfeature; and wherein a mean normalized contribution to the non-isotropic displacement between the micro-scale features is about 0.1% or less when measured between the part and an idealized master part.

The challenging microfeatures and arrays of challenging microfeatures can be created by combining a variety of protrusions and recesses, including channels, posts, and walls. In some aspects, precisely defined wall, posts, and channels are combined having aspect ratios from about 3:1 or about 5:1 and up to about 20:1 or about 50:1.

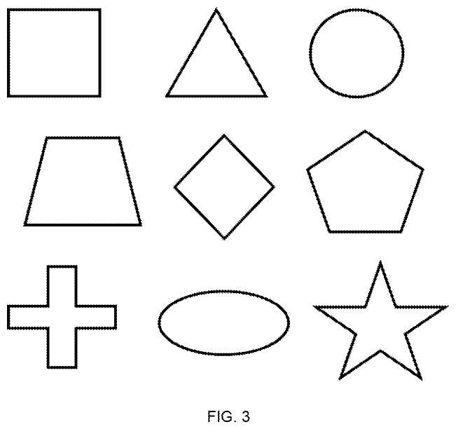

A variety of challenging microfeatures can be included in the parts and other articles described herein. As depicted in FIG. 3 the challenging microfeatures can include posts, wells, or other structures having a variety of cross-sections, including circular, elliptical, square, rectangular, pentagonal, hexagonal, octagonal, diamond shaped, and other complex cross-sections.

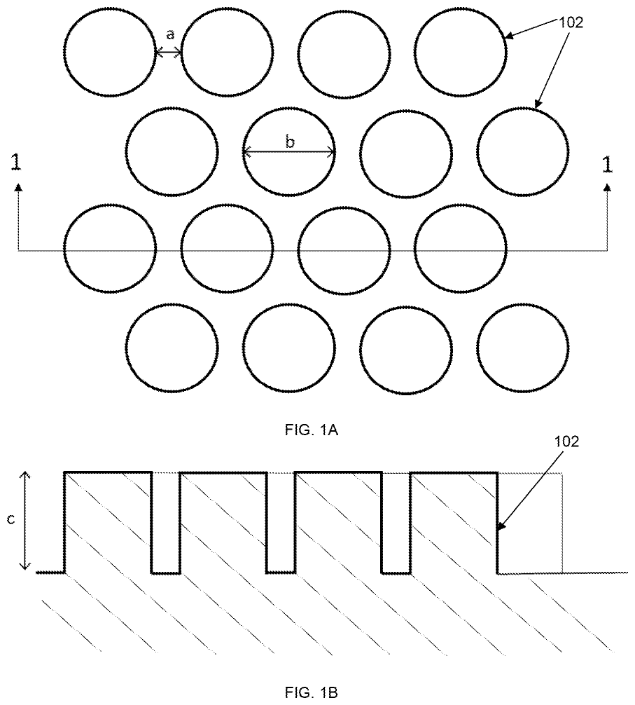

FIGS. 1A-1B depict exemplary challenging microfeatures including posts 102 having a circular cross-section. The posts 102 can have a width (“b”) of about 5 μm to about 50 μm, about 10 μm to about 30 μm, or about 15 μm to about 25 μm. The posts 102 can have a height (“c”) of about 40 μm to about 250 μm, about 40 μm to about 100 μm, or about 20 μm to about 75 μm. The posts 102 can be provided in a dense array of 5, 10, 15, 20 or more posts. The posts 102 can have a nearest neighbor spacing (“a”) as small as about 1 μm, 2 μm, 5 μm, 10 μm, or more.

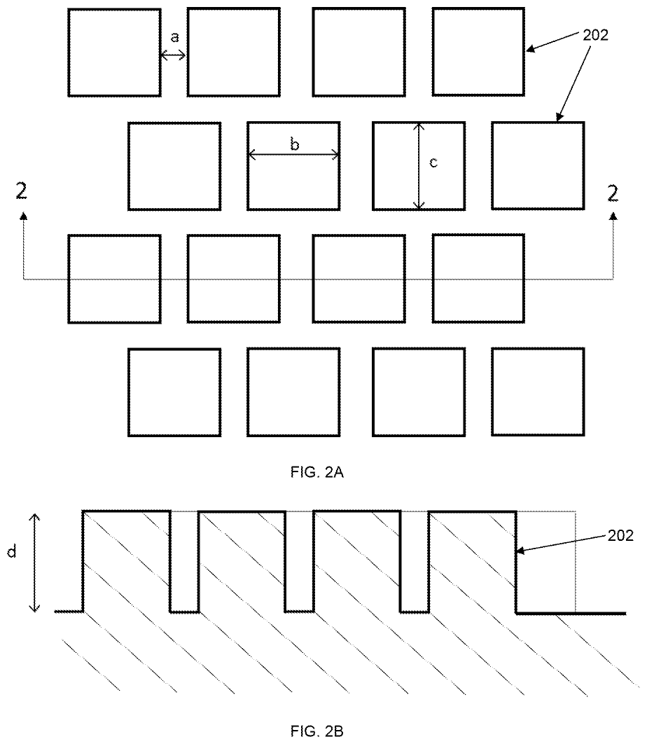

FIGS. 2A-2B depict exemplary challenging microfeatures including posts 202 having a rectangular cross-section. The posts 202 can have a length (“c”) and width (“b”) of about 5 μm to about 50 μm, about 10 μm to about 30 μm, or about 15 μm to about 25 μm. The posts 202 can have a height (“d”) of about 40 μm to about 250 μm, about 40 μm to about 100 μm, or about 20 μm to about 75 μm. The posts 202 can be provided in a dense array of 5, 10, 15, 20 or more posts. The posts 202 can have a nearest neighbor spacing (“a”) as small as about 1 μm, 2 μm, 5 μm, 10 μm, or more.

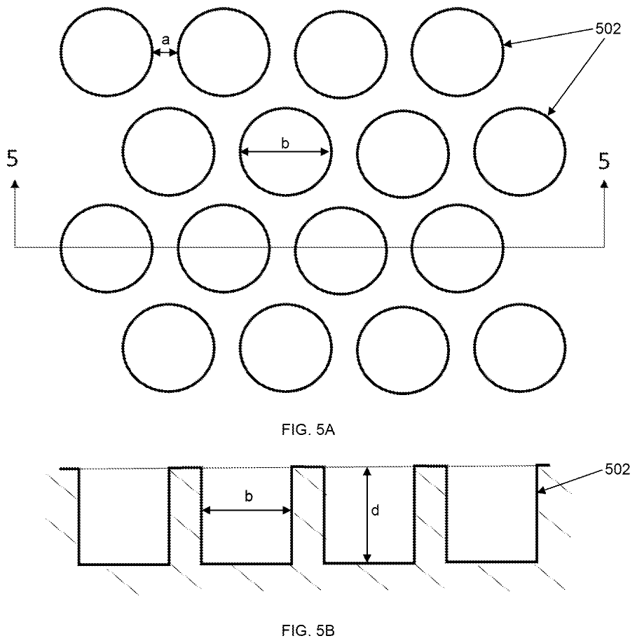

FIGS. 5A-5B depict exemplary challenging microfeatures including wells 502 having a circular cross-section, although wells 502 can also have any cross section depicted in FIG. 3. The wells 502 can have a width (“b”) of about 5 μm to about 50 μm, about 10 μm to about 30 μm, or about 15 μm to about 25 μm. The wells can have a depth (“d”) of about 40 μm to about 250 μm, about 40 μm to about 100 μm, or about 20 μm to about 75 μm. The wells can be provided in a dense array of 5, 10, 15, 20 or more wells. The wells can have a nearest neighbor spacing (“a”) as small as about 1 μm, 2 μm, 5 μm, 10 μm, or more.

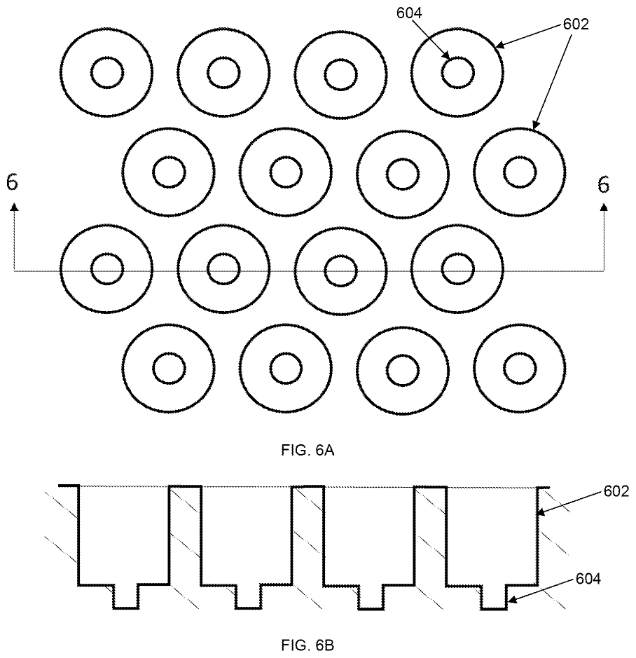

FIGS. 6A-6B depict exemplary challenging microfeatures including wells 602 having a smaller and shallower microwell 604 in the inside it. The microwells 604 depicted in FIGS. 6A-6B have a circular cross-section but can easily have other cross sections such as those depicted in FIG. 3. In some aspects, the larger outer well 602 has a cross-section depicted in FIG. 3 and the smaller inner well 604 has a different cross-section depicted in FIG. 3. The inner well 604 and out well 602 can each have dimensions described above so long as the inner well 604 has a width smaller than the outer well 602.

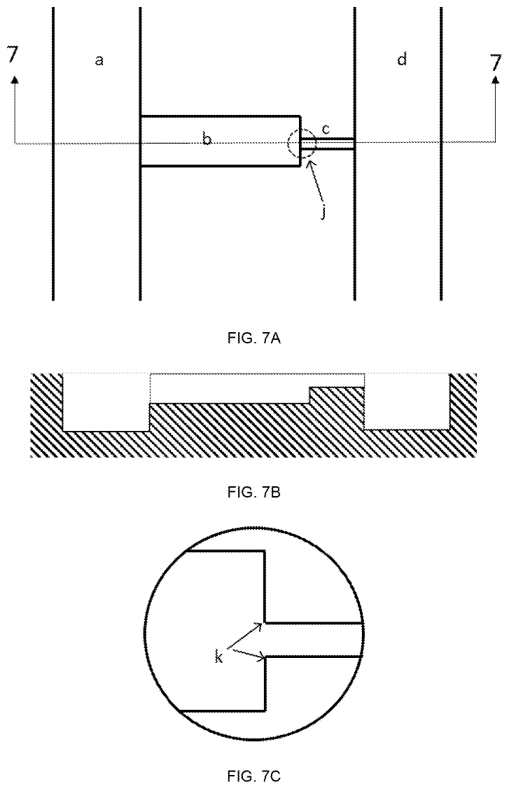

A first exemplary part is depicted in FIGS. 7A-7C demonstrating a part combining multiple challenging microfeatures. The part includes a main entry channel (a), an intermediate channel (b), a filter channel (c) and a main exit channel (d). As depicted in FIG. 7B, the intermediate channel and the filter channel can have a different depth and width than the main entry channel and/or the main exit channel. Any of the channels can have a high aspect ratio. Further, the sidewalls and surfaces of these channels can include additional challenging microfeatures such as pillars, posts, protrusions, wells, dimples, and the like. One or more of the surfaces can also include a textured or irregular surface. The junction (j) between the intermediate channel and the filter channel can be produced with very sharp corners and edges with extremely small radii of curvature (less than 5 μm, preferably less than 1 μm).

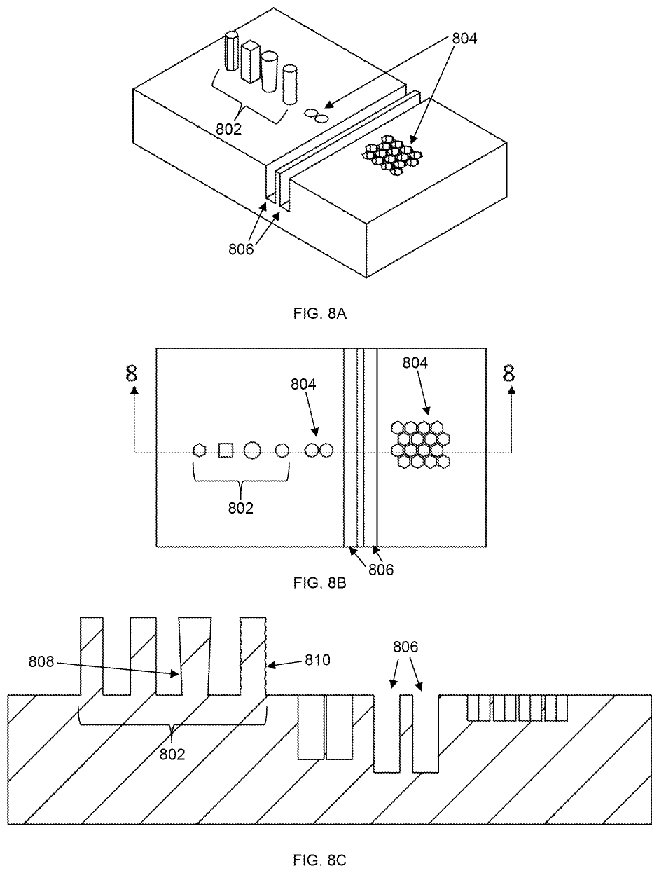

As depicted in FIGS. 8A-8C, the parts can combine any number of challenging microfeatures such as pillars 802 and wells 804 having the same or different cross sections, the same or different depths, and being spaced or closely packed in an array on the part. The features can include channels 806, pillars 802, or wells 804 having large aspect ratios as described herein. The part depicted in FIGS. 8A-8C includes features having undercuts 808 and textured vertical walls 810 on challenging microfeatures.

In some aspects, a mean normalized contribution to the non-isotropic displacement that is computed by subtracting the isotropic distortion relative to the master prior to measuring the displacement. In some aspects, a mean normalized contribution to the non-isotropic displacement is computed by subtracting a static amount of isotropic shrinkage prior to measuring the displacement, wherein the static amount of isotropic shrinkage is a percentage based upon the composition of the thermoplastic.

The thermoplastic parts and articles of manufacture can be made with exceptionally low part-to-part variability owing to the reproducible macro-scale dimensions. This can provide for a plurality of parts or articles of manufacture with the same or nearly the same feature accuracy and dimensions.

In some aspects, a plurality of thermoplastic parts or articles of manufacture are provided having precision micro-scale features and reproducible macro-scale dimensions; wherein the precision micro-scale features on each part comprise at least one challenging microfeature; and wherein a mean normalized displacement of the micro-scale features is about 0.1% or less when measured between the parts in the plurality of thermoplastic parts.

In some aspects, a plurality of thermoplastic parts or articles of manufacture are provided having precision micro-scale features and reproducible macro-scale dimensions; wherein the precision micro-scale features on each part comprise at least one challenging microfeature; and wherein a maximum normalized displacement of the micro-scale features is about 0.1% or less when measured between the parts in the plurality of thermoplastic parts.

In some aspects, a plurality of thermoplastic parts or articles of manufacture are provided having precision micro-scale features and reproducible macro-scale dimensions; wherein the precision micro-scale features on each part comprise at least one challenging microfeature; and wherein a maximum displacement between the micro-scale features is about 10 μm or less when measured between the parts in the plurality of thermoplastic parts.

In some aspects, a plurality of thermoplastic parts or articles of manufacture are provided having precision micro-scale features and reproducible macro-scale dimensions; wherein the precision micro-scale features on each part comprise at least one challenging microfeature; and wherein a mean displacement between the micro-scale features is about 10 μm or less when measured between the parts in the plurality of thermoplastic parts.

In some aspects, the plurality of thermoplastic parts or articles of manufacture have one, two, three, or four of the following properties:
i. a mean normalized displacement of the micro-scale features is about 0.1%, 0.07%, 0.06%, or less when measured between the parts in the plurality of thermoplastic parts;
ii. a maximum normalized displacement of the micro-scale features is about 0.5%, 0.2%, 0.1% or less when measured between the parts in the plurality of thermoplastic parts;
iii. a maximum displacement between the micro-scale features is about 100 μm, 50 μm, 10 μm or less when measured between the parts in the plurality of thermoplastic parts; and
iv. a mean displacement between the micro-scale features is about 100 μm, 50 μm, 10 μm or less when measured between the parts in the plurality of thermoplastic parts.

Challenging microfeatures cannot typically be produced with conventional hard tool embossing or injection molding. Challenging microfeatures include features that, because of the geometry, cannot be readily demolded from a rigid mold without damage to one or both of the part and mold. Examples include parts with negative draft angles, especially for small microfeatures, and features or parts with textures or structures on vertical walls that create resistance to demolding.

In some aspects, the challenging microfeature includes a recess having at least one lateral dimension of about 350 μm, about 300 μm, about 250 μm, about 200 μm, about 150 μm, about 100 μm or less and an aspect ratio (height:width) of about 2:1, about 3:1, about 4:1 and up to about 10:1, 20:1, 50:1 or more.

In some aspects, the challenging microfeature includes a protrusion having at least one lateral of about 350 μm, about 300 μm, about 250 μm, about 200 μm, about 150 μm, about 100 μm or less and an aspect ratio (height:width) of about 2:1, about 3:1, about 4:1 and up to about 10:1, 20:1, 50:1 or more.

In some aspects, the challenging microfeature includes a post having at least one lateral of about 350 μm, about 300 μm, about 250 μm, about 200 μm, about 150 μm, about 100 μm or less and an aspect ratio (height:width) of about 2:1, about 3:1, about 4:1 and up to about 10:1, 20:1, 50:1 or more.

In some aspects, the challenging microfeature includes a well having at least one lateral of about 350 μm, about 300 μm, about 250 μm, about 200 μm, about 150 μm, about 100 μm or less and an aspect ratio (height:width) of about 2:1, about 3:1, about 4:1 and up to about 10:1, 20:1, 50:1 or more.

In some aspects, the challenging microfeature includes a channel having at least one lateral of about 350 μm, about 300 μm, about 250 μm, about 200 μm, about 150 μm, about 100 μm or less and an aspect ratio (height:width) of about 2:1, about 3:1, about 4:1 and up to about 10:1, 20:1, 50:1 or more.

In some aspects, the aspect ratio is about 2:1 to about 100:1, about 2:1 to about 50:1, about 2:1 to about 20:1, about 5:1 to about 20:1, about 5:1 to about 50:1, about 10:1 to about 20:1, or greater.

In some aspects, the challenging microfeature includes a recess having at least one lateral dimension of about 350 μm, about 300 μm, about 250 μm, about 200 μm, about 150 μm, about 100 μm or less and vertical wall with a draft angle of about 3°, about 2°, about 1°, about 0°, about −1° and down to −5° or −10°, or less.

In some aspects, the challenging microfeature includes a protrusion having at least one lateral dimension of about 350 μm, about 300 μm, about 250 μm, about 200 μm, about 150 μm, about 100 μm or less and vertical wall with a draft angle of about 3°, about 2°, about 1°, about 0°, about −1° and down to −5° or −10°, or less.

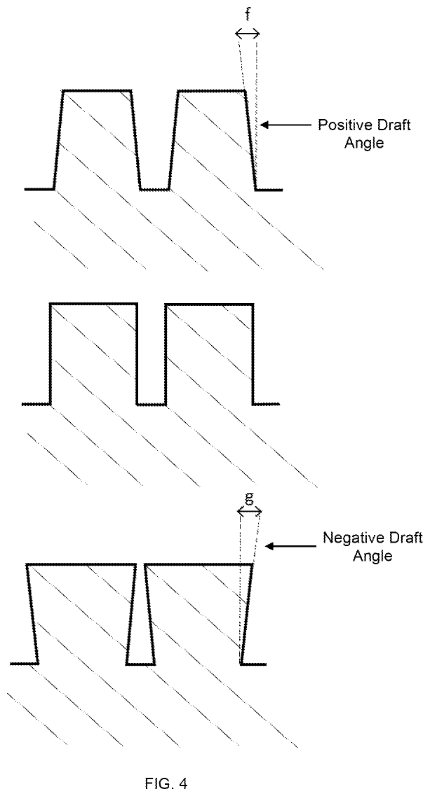

In some aspects, the draft angle is about 1°, about 0°, about −1°, or less. The challenging microfeatures such as pillars, wells, and channels with high aspect ratios can be made having a variety of draft angles. FIG. 4 depicts features having a positive (“f”), zero (vertical wall), and negative (“g”) draft angle. The negative draft angles in FIG. 4 and FIG. 8 result in features having an undercut, as that term is used herein, which are not possible with rigid tooling approaches.

In some aspects, the challenging microfeature includes a recess having at least one lateral dimension of about 350 μm, about 300 μm, about 250 μm, about 200 μm, about 150 μm, about 100 μm or less and at least one undercut.

In some aspects, the challenging microfeature includes a protrusion having at least one lateral of about 350 μm, about 300 μm, about 250 μm, about 200 μm, about 150 μm, about 100 μm or less and at least one undercut.

In some aspects, the challenging microfeature includes a post having at least one lateral of about 350 μm, about 300 μm, about 250 μm, about 200 μm, about 150 μm, about 100 μm or less and at least one undercut.

In some aspects, the challenging microfeature includes a well having at least one lateral of about 350 μm, about 300 μm, about 250 μm, about 200 μm, about 150 μm, about 100 μm or less and at least one undercut.

In some aspects, the challenging microfeature includes a channel having at least one lateral of about 350 μm, about 300 μm, about 250 μm, about 200 μm, about 150 μm, about 100 μm or less and at least one undercut.

In some aspects, the challenging microfeature includes a recess having at least one lateral dimension of about 350 μm, about 300 μm, about 250 μm, about 200 μm, about 150 μm, about 100 μm or less and at least one textured vertical surface.

In some aspects, the challenging microfeature includes a protrusion having at least one lateral of about 350 μm, about 300 μm, about 250 μm, about 200 μm, about 150 μm, about 100 μm or less and at least one textured vertical surface.

In some aspects, each of the parts in the plurality of parts comprise at least one macro-scale feature having at least one textured vertical surface.

The textured vertical surface can include a threaded post, a scalloped wall, or similar textured vertical wall. The textured vertical surface can include a micron-scale texture selected from the group consisting of micron-scale grooves, micron-scale dimples, micron-scale texture, and a combination thereof.

In some aspects, each of the thermoplastic parts or articles of manufacture in the plurality includes a first lateral dimension and a second lateral dimension perpendicular to the first lateral dimension, wherein the first lateral dimension and the second lateral dimension have dimensions of about 5 mm or 20 mm to about 1000 mm or 2000 mm; and a vertical dimension perpendicular to the first and second lateral dimensions, the vertical dimension having a dimension of about 100 μm or 500 μm to about 5000 μm or 10000 μm.

In some aspects, each of the thermoplastic parts or articles of manufacture in the plurality includes a first challenging microfeature on a first face of the thermoplastic part; and a second challenging microfeature on a second face opposite the first face; wherein an x-y alignment between the first challenging microfeature and the second challenging microfeature is about 100 μm, about 80 μm, about 60 μm, about 40 μm, or less.

In some aspects, a thickness variation of the vertical dimension is about 10 μm/cm, about 5 μm/cm, or less.

In some aspects, the challenging microfeature comprises a smooth surface having a nanometer scale smoothness.

In some aspects, each of the thermoplastic parts or articles of manufacture in the plurality has a macroscale feature; wherein a mean normalized displacement between the macroscale feature and the challenging microfeature is about 1%, about 0.5%, about 0.1% or less when measured between each of the parts in the plurality of parts. Macroscale features can include, for example, reagent wells, through holes, etc.

In some aspects, the thermoplastic comprises polyethylene (PE), polypropylene (PP), poly(vinyl chloride) (PVC), polycarbonate (PC), polyethylene terephthalate (PET), cyclic olefin polymer (COP), cyclic olefin copolymer (COC), poly(methyl methacrylate) (PMMA), polyamides, polyimides, polyesters, polyurethanes, polyoxymethylene, thermoplastic fluoropolymers (e.g., ethylene tetrafluoroethylene (ETFE), perfluoroalkoxy alkanes (PFA), Polyvinylidene fluoride or polyvinylidene difluoride (PVDF), Fluorinated ethylene propylene (FEP), etc.), styrenic block copolymers (e.g., styrene butadiene styrene (SBS), styrene ethylene butylene styrene (SEBS), Styrene isoprene block copolymer (SIS), styrene isobutylene-block-styrene (SIBS), etc.) or copolymers thereof and copolymers thereof with other polymers.

Methods of Making Thermoplastic Parts and Other Articles of Manufacture

Systems and methods of hybrid tooling are described in PCT/US2019/063338 entitled “THERMOPLASTIC FORMING TOOLS, ASSEMBLAGES, AND METHODS OF MAKING AND METHODS OF USE THEREOF”, filed 29 Nov. 2019, the contents of which are incorporated by reference herein. The tools and assemblages described can be used for forming thermoplastic components with precisely dimensioned micro-scale features, even with high aspect ratios, while also maintaining long-range macro-scale reproducibility of the component. By combining rigid tooling with thin elastomer layers on the cavity-forming surface, the tools described are capable of achieving the benefits of both rigid hard tool embossing and soft tool embossing approaches. The tools enable the production of challenging microfeatures only capable with soft tooling approaches while maintaining the positional/dimensional accuracy and reproducibility of hard tool micro-injection molding.

In some aspects, a thermoplastic forming assemblage for forming a thermoplastic component is provided. The assemblages are capable of forming components having precision micro-scale features and reproducible macro-scale dimensions. In various aspects, the thermoplastic forming assemblage includes both a bottom tool and a top tool. In some aspects, when the tool include multiple wells for forming multiple components, the assemblage can include multiple top tools. For example, in some aspects the assemblage has 3, 4, or more cavities and an equal number of top tools.

The top tool and the bottom tool come together to form a cavity for forming the thermoplastic component. In some aspects, the top tool includes a first rigid tool body having a first cavity-forming side with at least one protrusion. The top tool can also include a first elastomer layer conformally coating the at least one protrusion to create a first cavity-forming surface. The thermoplastic forming assemblage will also have a bottom tool. In some aspects, the bottom tool includes a second rigid tool body having a second-cavity forming side with at least one recess, wherein the at least one recess is configured to receive the at least one protrusion of the top tool when the assemblage is in a closed position. In some aspects, the bottom tool includes a second elastomer layer conformally coating the at least one recess to create a second cavity-forming surface. When the assemblage is in the closed position, the first cavity-forming surface and the second cavity-forming surface can define a cavity for forming the thermoplastic component.

The tools and assemblages can be used to form thermoplastic components with precision micro-scale features. In some aspects, one or both of the first cavity-forming surface and the second cavity-forming surface include a feature-forming surface that define the precision micro-scale features when forming the thermoplastic component. The feature-forming surface can include wells, pillars, dimples, pores, channels, ridges, more complex geometric structures, or any combination thereof.

The hybrid tooling approach that combines a rigid tool body with a thin elastomer coating allows for tighter dimensional control across all feature sizes than can be achieved by either rigid tooling or elastomeric tooling alone. Geometric features of thermoplastic parts can generally be defined as macro-scale or micro-scale. Features defined as macro-scale typically have a length, width, height, pitch, and radius of curvature of at least 1 millimeter. Features defined as micro-scale typically have at least one characteristic from the set of length, width, height, pitch, or radius of curvature that is less than one millimeter. Rigid tooling without elastomer coating typically can produce thermoplastic parts with macro-features that vary by less than 0.1% from part to part, but typically cannot produce most types of micro-features without large variations (more than 10%). Elastomeric tooling without a rigid body can typically produce thermoplastic parts with micro-features that vary by less than 1% from part to part, but typically produce macro-features that vary by at least 5%. The hybrid tooling described herein has been demonstrated in some aspects to produce thermoplastic parts with macro-features that vary less than 0.1% and micro-features that vary by less than 1%.

The rigid tool bodies can provide for reproducible macro-scale dimensions in the thermoplastic component when formed. One problem associated with soft tool embossing is that the components produced can have large-scale structural deviations and macro-scale dimensions that are not reproducible reliably without unwanted variations. For example, in some aspects the methods provided herein are capable of producing thermoplastic components with a dimensional tolerance of about 5%, about 1%, about 0.1%, or less.

The cavity forming surfaces of the top and bottom tools are formed from a thin elastomer layer coating at least a portion of the cavity-forming sides of the tools. The cavity forming surfaces can include a feature forming surface for forming the precision micro-scale features in the thermoplastic component. The elastomer layers allow for the formation of the small micro-scale features, even for very small features sizes with high aspect ratios, and for the micro-scale features to be more readily released from the mold after formation.

The thermoplastic forming tools and assemblages described herein can be used to make a variety of components from thermoplastics and, in some cases, from other materials such as polymer thermosets and composite materials. The methods can include hot embossing, injection molding, compression molding, and combinations or variations thereof.

In some aspects, the methods include a hot embossing method. The embossing process requires a thermoplastic forming tool or assemblage described herein, a polymer “blank” and a method of applying heat and/or pressure to the thermoplastic forming tool or assemblage. Typically, the polymer blank is first placed in the embossing tool cavity, the temperature of the tool and blank are then raised above the glass transition temperature of the blank material, and then pressure is applied to the blank forcing the polymer to flow and take the form of the cavity defined by the tool. The tool and blank are then cooled below the glass transition temperature of the polymer, after which the embossed thermoplastic component can be demolded from the cavity.

Embossing Cycle:

A standard embossing cycle can be conducted as follows. After the blank has been placed in the tooling, the mold is compressed to an initial “contact pressure” while evacuating the cavity of air through the vacuum port. The contact pressure ensures adequate thermal contact between the tool's interior surfaces and the blank. While maintaining the contact force, the tool temperature is raised at a given ramp rate to the embossing temperature. Once the tool temperature has stabilized at the embossing temperature, the compressive force is ramped up to achieve the desired “embossing pressure” which is held for the duration of the “soak time”. The soak time should be sufficiently long to allow the blank material to flow and fill all the recesses of the mold cavity. While maintaining the “embossing pressure”, the mold is cooled to the demolding temperature after which the pressure on the mold is released.

Heating and cooling of the mold can be achieved by direct contact with a heated/cooled platen. Heating and cooling elements can also be directly embedded into the tooling. Other methods of heating include but are not limited to inductive heating and radiative heating of the mold. Other methods of cooling include thermoelectric cooling, and conductive or convective cooling with a cooling fluid or gas. Compressive force can be applied using a motorized linear stage, pneumatic or hydraulic press or under the gravitational force of a weight.

Vacuum can be applied to the cavity to evacuate any air or other vapors generated while heating the blank that get trapped between the polymer and recesses on the tooling surface. Evacuation of oxygen from the cavity also helps prevent thermal oxidation of the polymer during the embossing process. The cavity may also be purged with an inert gas such as nitrogen or argon. A combination of evacuation and purging can be used to minimize oxygen, moisture, and other contamination in the cavity.

In some aspects the equipment includes top and bottom thermally controlled platen mounted on a force controlled motorized compressive stage to which the tools can be mounted or otherwise placed on. The top and bottom platens are actively heated with embedded resistive heating cartridges and actively cooled with an embedded liquid cooling circuit running cooled water from a chiller. The top and bottom tools can sit freely on the bottom platen or they can be attached to the top and bottom platens respectively.

Part Removal:

Once the component has been cooled, the tool components are separated and the embossed part can be demolded from the tool. Venting the cavity with air or another suitable gas can be used to break the vacuum in the cavity and help eject the embossed structure from the tool(s). The cavity could be vented through the same port used for evacuating the cavity or one or multiple ports connecting to the cavity or vacuum channel The embossed part can be removed by uniformly pulling it in a directly normal to the surface of the tool or it may be lifted from one side of the part and gradually removed in a peeling motion. Removal for parts from the tool can be aided by incorporating ejector pins into the mold. Ejection pins can be mechanically, electrically or pneumatically activated. The ejection pins can be located in the main cavity, or alternatively in an overflow cavity where pins will contact an area that will be trimmed off after ejection. Ejection pins may be hidden underneath the elastomer layer—once activated the pin can deform stretch the elastomer layer and push on the molded part. This configuration allows use of ejector pins to eject the molded part without the appearance of visible features on the part associated with the discontinuity between ejector pins and the surrounding tool material. Placement and removal of blanks and embossed parts can be facilitated with automated equipment to increase throughput and reduce labor.

Blank Substrate “Blanks”

The thermoplastic components can be made from a thermoplastic “blank” substrate. In some aspects, the blank substrate will have a volume within about 10%, about 5%, about 1%, or about 0.1% of a volume of the cavity formed by the first cavity-forming surface and the second cavity-forming surface. In some aspects, the blank volume will be slightly more than the cavity volume. This can be used to produce higher quality components with minimal or essentially zero flashing. An exemplary blank can be roughly the size of a standard microscope slide. However, the blank can in other applications have any volume or dimensions that accommodate the cavity volume of the tooling. In some aspects, blanks are not used at all, and the thermoplastic can be introduced as a thermoplastic grind or powder, or can be flowed in a molten or partially molten state into the chamber through a port or channel.

Suitable thermoplastic polymers include but are not limited to polyethylene (PE), polypropylene (PP), poly(vinyl chloride) (PVC), polycarbonate (PC), polyethylene terephthalate (PET), cyclic olefin polymer (COP), cyclic olefin copolymer (COC), poly(methyl methacrylate) (PMMA), polyamides, polyimides, polyesters, polyurethanes, polyoxymethylene, thermoplastic fluoropolymers (e.g., ethylene tetrafluoroethylene (ETFE), perfluoroalkoxy alkanes (PFA), Polyvinylidene fluoride or polyvinylidene difluoride (PVDF), Fluorinated ethylene propylene (FEP), etc.), styrenic block copolymers (e.g., styrene butadiene styrene (SBS), styrene ethylene butylene styrene (SEBS), Styrene isoprene block copolymer (SIS), styrene isobutylene-block-styrene (SIBS), etc.) or copolymers thereof and copolymers thereof with other polymers. Ideally the thermoplastic will have a melt flow index at the embossing temperature sufficient to allow full formation of the microfeatures to be embossed. The blank may also be made of a thermoset polymer such as a high temperature vulcanization (HTV) silicone, or an epoxy resin. The blank can also be a composite material such as a multilayer polymer laminate, or a polymer matrix filled with an inorganic additive such glass fiber, silica or clay. The blank material may also contain additives that are commonly added to injection molding resins such as antimicrobials, light absorptive agents, clarifying agents, mold release, slip agents, and antistatic additives.

Methods of Measuring Thermoplastic Articles

Multiple methods are provided for comparing the dimensions, features, and reproducibility in thermoplastic articles and parts thereof. Those methods are described in more detail herein. In some instances, those methods include comparison to a corresponding reference or target article or part.

To evaluate the feature position accuracy, the coordinates of selected microfeatures on a part were measured and displacements were calculated the with respect to a reference (master structure or another part). The analysis was performed for both soft and hybrid tools made from the same master structure.

The term “displacement,” as used herein to refer to a measure of difference between a thermoplastic part and a reference part, is the distance (Euclidian norm) between an identified point on the thermoplastic part and the corresponding point on the reference part. The “displacement” will sometimes be denoted as WI. Each of the points may, for example, correspond to the locations of a microfeature on the part.

The term “mean displacement,” as used herein to refer to a measure of difference between a thermoplastic part and a reference part, is an average of the displacement averaged over multiple points (typically 16) on the part. The mean displacement can be computed via the formula Σ|\vec{μₙ}|/n for n points, each with a displacement of |\vec{μₙ}|.

The term “maximum displacement,” used herein to refer to a measure of difference between a thermoplastic part and a reference part, is the maximum displacement measured over multiple points (typically 16).

The term “normalized displacement,” as used herein to refer to a measure of difference between a thermoplastic part and a reference part, is the distance (Euclidian norm) between an identified point on the thermoplastic part and the corresponding point on the reference part normalized (divided by) the distance between the point on the reference part and the origin. The normalized displacement can be computed via the formula |\vec{μₙ}|/|\vec{R_{ref}}| where |\vec{R_{ref}}| is the distance between the point on the reference part and the origin.

The term “mean normalized displacement,” as used herein, refers to the normalized displacement averaged over a number of points (typically 16).

Thermoplastic shrinkage from embossing (˜0.5%) can complicate the comparison since it can result in displacements on the same order or magnitude as those caused by tooling deformation. The shrinkage is mostly isotropic and can be accounted for using a scaling factor. To account for the isotropic shrinkage associated with the material, the isotropic component of the shrinkage was removed and the mean normalized displacement of the anisotropic contributions was measured for parts from each method compared to the master.

In order to demonstrate that the isotropic effects are determined by the material and not associated with the method, the isotropic shrinkage was next accounted for by applying a fixed isotropic shrinkage across the parts, isolating the anisotropic portion. The mean normalized displacement of the anisotropic contributions was again measured for parts from each method compared to the master.

In order to compare the anisotropic distortions of the articles, a fully anisotropic scaling (x scaling=A(1+ε), y scaling=A(1−ε)) was applied comparing the part to the master. The anisotropy parameter ε was used to compare the methods.

Finally, articles within a batch produced by the same method were compared internally to each other to ascertain the part-to-part variation.

Certain Aspects According to the Disclosure

The above disclosure will be better understood upon reading the following numbered aspects which should not be confused with the claims. In some instances, one or more of the numbered aspects can be combined with other aspects described herein without departing from the disclosure.

Aspect 1. A plurality of thermoplastic parts or other articles of manufacture according to any aspects described herein, having precision micro-scale features and reproducible macro-scale dimensions; wherein the precision micro-scale features on each part comprise at least one challenging microfeature; and wherein a mean normalized displacement of the micro-scale features is about 0.1% or less when measured between the parts in the plurality of thermoplastic parts.

Aspect 2. A plurality of thermoplastic parts or other articles of manufacture according to any aspects described herein, having precision micro-scale features and reproducible macro-scale dimensions; wherein the precision micro-scale features on each part comprise at least one challenging microfeature; and wherein a maximum normalized displacement of the micro-scale features is about 0.1% or less when measured between the parts in the plurality of thermoplastic parts.

Aspect 3. A plurality of thermoplastic parts or other articles of manufacture according to any aspects described herein, having precision micro-scale features and reproducible macro-scale dimensions; wherein the precision micro-scale features on each part comprise at least one challenging microfeature; and wherein a maximum displacement between the micro-scale features is about 10 μm or less when measured between the parts in the plurality of thermoplastic parts.

Aspect 4. A plurality of thermoplastic parts or other articles of manufacture according to any aspects described herein, having precision micro-scale features and reproducible macro-scale dimensions; wherein the precision micro-scale features on each part comprise at least one challenging microfeature; and wherein a mean displacement between the micro-scale features is about 10 μm or less when measured between the parts in the plurality of thermoplastic parts.

Aspect 5. A plurality of thermoplastic parts or other articles of manufacture according to any aspects described herein, comprising two, three, or four of the following: (i) wherein a mean normalized displacement of the micro-scale features is about 0.1%, 0.07%, 0.06%, or less when measured between the parts in the plurality of thermoplastic parts; (ii) wherein a maximum normalized displacement of the micro-scale features is about 0.5%, 0.2%, 0.1% or less when measured between the parts in the plurality of thermoplastic parts; (iii) wherein a maximum displacement between the micro-scale features is about 100 μm, 50 μm, 10 μm or less when measured between the parts in the plurality of thermoplastic parts; and (iv) wherein a mean displacement between the micro-scale features is about 100 μm, 50 μm, 10 μm or less when measured between the parts in the plurality of thermoplastic parts.

Aspect 6. A plurality of thermoplastic parts or other articles of manufacture according to any aspects described herein, wherein the challenging microfeature comprises a recess having at least one lateral dimension of about 250 μm or less and an aspect ratio (height:width) of at least 2:1.

Aspect 7. A plurality of thermoplastic parts or other articles of manufacture according to any aspects described herein, wherein the challenging microfeature comprises a protrusion having at least one lateral dimension of about 250 μm or less and an aspect ratio (height:width) of at least 2:1.

Aspect 8. A plurality of thermoplastic parts or other articles of manufacture according to any aspects described herein, wherein the challenging microfeature comprises a post having at least one lateral dimension of about 250 μm or less and an aspect ratio (height:width) of at least 2:1.

Aspect 9. A plurality of thermoplastic parts or other articles of manufacture according to any aspects described herein, wherein the challenging microfeature comprises a well having at least one lateral dimension of about 250 μm or less and an aspect ratio (height:width) of at least 2:1.

Aspect 10. A plurality of thermoplastic parts or other articles of manufacture according to any aspects described herein, wherein the challenging microfeature comprises a channel or ridge having at least one lateral dimension of about 250 μm or less and an aspect ratio (height:width) of at least 2:1.

Aspect 11. A plurality of thermoplastic parts or other articles of manufacture according to any aspects described herein, wherein the aspect ratio is about 2:1 to about 100:1, about 2:1 to about 50:1, about 2:1 to about 20:1, about 5:1 to about 20:1, about 5:1 to about 50:1, about 10:1 to about 20:1, or greater.

Aspect 12. A plurality of thermoplastic parts or other articles of manufacture according to any aspects described herein, wherein the challenging microfeature comprises a recess having at least one lateral dimension of about 250 μm or less and a vertical wall with a draft angle of about 2° or less.

Aspect 13. A plurality of thermoplastic parts or other articles of manufacture according to any aspects described herein, wherein the challenging microfeature comprises a protrusion having at least one lateral dimension of about 250 μm or less and a vertical wall with a draft angle of about 2° or less.

Aspect 14. A plurality of thermoplastic parts or other articles of manufacture according to any aspects described herein, wherein the draft angle is about 1°, about 0°, about −1°, or less.

Aspect 15. A plurality of thermoplastic parts or other articles of manufacture according to any aspects described herein, wherein the challenging microfeature comprises a recess having at least one lateral dimension of about 250 μm or less and at least one undercut.

Aspect 16. A plurality of thermoplastic parts or other articles of manufacture according to any aspects described herein, wherein the challenging microfeature comprises a protrusion having at least one lateral dimension of about 250 μm or less and at least one undercut.

Aspect 17. A plurality of thermoplastic parts or other articles of manufacture according to any aspects described herein, wherein the challenging microfeature comprises a recess having at least one lateral dimension of about 250 μm or less and at least one textured vertical surface.

Aspect 18. A plurality of thermoplastic parts or other articles of manufacture according to any aspects described herein, wherein the challenging microfeature comprises a protrusion having at least one lateral dimension of about 250 μm or less and at least one textured vertical surface.

Aspect 19. A plurality of thermoplastic parts or other articles of manufacture according to any aspects described herein, wherein the textured vertical surface comprises a threaded post, a scalloped wall, or similar textured vertical wall.

Aspect 20. A plurality of thermoplastic parts or other articles of manufacture according to any aspects described herein, wherein the textured vertical surface comprises a micron-scale texture selected from the group consisting of micron-scale grooves, micron-scale dimples, micron-scale texture, and a combination thereof.

Aspect 21. A plurality of thermoplastic parts or other articles of manufacture according to any aspects described herein, wherein the lateral dimension is about 200 μm, 150 μm, 100 μm, 50 μm, or less.

Aspect 22. A plurality of thermoplastic parts or other articles of manufacture according to any aspects described herein, wherein each of the thermoplastic parts in the plurality of thermoplastic parts comprises a first lateral dimension and a second lateral dimension perpendicular to the first lateral dimension, wherein the first lateral dimension and the second lateral dimension have dimensions of about 5 mm or 20 mm to about 1000 mm or 2000 mm; and a vertical dimension perpendicular to the first and second lateral dimensions, the vertical dimension having a dimension of about 100 μm or 500 μm to about 5000 μm or 10000 μm.

Aspect 23. A plurality of thermoplastic parts or other articles of manufacture according to any aspects described herein, wherein each of the thermoplastic parts in the plurality of thermoplastic parts comprises: a first challenging microfeature on a first face of the thermoplastic part; and a second challenging microfeature on a second face opposite the first face; wherein an x-y alignment between the first challenging microfeature and the second challenging microfeature is about 100 μm, about 80 μm, about 60 μm, about 40 μm, or less.

Aspect 24. A plurality of thermoplastic parts or other articles of manufacture according to any aspects described herein, wherein a thickness variation of the vertical dimension is about 10 μm/cm, about 5 μm/cm, or less.

Aspect 25. A plurality of thermoplastic parts or other articles of manufacture according to any aspects described herein, wherein the challenging microfeature comprises a smooth surface having a nanometer scale smoothness.

Aspect 26. A plurality of thermoplastic parts or other articles of manufacture according to any aspects described herein, wherein each of the thermoplastic parts in the plurality of thermoplastic parts comprises a macroscale feature; wherein a mean normalized displacement between the macroscale feature and the challenging microfeature is about 1%, about 0.5%, about 0.1% or less when measured between each of the parts in the plurality of parts.

Aspect 27. A plurality of thermoplastic parts or other articles of manufacture according to any aspects described herein, wherein the thermoplastic comprises polyethylene (PE), polypropylene (PP), poly(vinyl chloride) (PVC), polycarbonate (PC), polyethylene terephthalate (PET), cyclic olefin polymer (COP), cyclic olefin copolymer (COC), poly(methyl methacrylate) (PMMA), polyamides, polyimides, polyesters, polyurethanes, polyoxymethylene, thermoplastic fluoropolymers (e.g., ethylene tetrafluoroethylene (ETFE), perfluoroalkoxy alkanes (PFA), Polyvinylidene fluoride or polyvinylidene difluoride (PVDF), Fluorinated ethylene propylene (FEP), etc.), styrenic block copolymers (e.g., styrene butadiene styrene (SBS), styrene ethylene butylene styrene (SEBS), Styrene isoprene block copolymer (SIS), styrene isobutylene-block-styrene (SIBS), etc.) or copolymers thereof and copolymers thereof with other polymers.

Aspect 28. A plurality of thermoplastic parts or other articles of manufacture according to any aspects described herein, wherein each of the parts in the plurality of parts comprise at least one macro-scale feature having at least one textured vertical surface.

Aspect 29. A thermoplastic part or other article of manufacture according to any aspect described herein and having precision micro-scale features and reproducible macro-scale dimensions; wherein the precision micro-scale features comprise at least one challenging microfeature; and wherein a mean normalized contribution to the non-isotropic displacement between the micro-scale features is about 0.1% or less when measured between the part and an idealized master part.

Aspect 30. A thermoplastic part or other article of manufacture according to any aspect described herein, wherein the mean normalized contribution to the non-isotropic displacement is computed by subtracting the isotropic distortion relative to the master prior to measuring the displacement.

Aspect 31. A thermoplastic part or other article of manufacture according to any aspect described herein, wherein the mean normalized contribution to the non-isotropic displacement is computed by subtracting a static amount of isotropic shrinkage prior to measuring the displacement, wherein the static amount of isotropic shrinkage is a percentage based upon the composition of the thermoplastic.

Aspect 32. A thermoplastic part or other article of manufacture according to any aspect described herein, wherein the challenging microfeature comprises a recess having at least one lateral dimension of about 250 μm or less and an aspect ratio (height:width) of at least 2:1.

Aspect 33. A thermoplastic part or other article of manufacture according to any aspect described herein, wherein the challenging microfeature comprises a protrusion having at least one lateral dimension of about 250 μm or less and an aspect ratio (height:width) of at least 2:1.

Aspect 34. A thermoplastic part or other article of manufacture according to any aspect described herein, wherein the challenging microfeature comprises a post having at least one lateral dimension of about 250 μm or less and an aspect ratio (height:width) of at least 2:1.

Aspect 35. A thermoplastic part or other article of manufacture according to any aspect described herein, wherein the challenging microfeature comprises a well having at least one lateral dimension of about 250 μm or less and an aspect ratio (height:width) of at least 2:1.

Aspect 36. A thermoplastic part or other article of manufacture according to any aspect described herein, wherein the challenging microfeature comprises a channel or ridge having at least one lateral dimension of about 250 μm or less and an aspect ratio (height:width) of at least 2:1.

Aspect 37. A thermoplastic part or other article of manufacture according to any aspect described herein, wherein the aspect ratio is about 2:1 to about 100:1, about 2:1 to about 50:1, about 2:1 to about 20:1, about 5:1 to about 20:1, about 5:1 to about 50:1, about 10:1 to about 20:1, or greater.

Aspect 38. A thermoplastic part or other article of manufacture according to any aspect described herein, wherein the challenging microfeature comprises a recess having at least one lateral dimension of about 250 μm or less and a vertical wall with a draft angle of about 2° or less.

Aspect 39. A thermoplastic part or other article of manufacture according to any aspect described herein, wherein the challenging microfeature comprises a protrusion having at least one lateral dimension of about 250 μm or less and a vertical wall with a draft angle of about 2° or less.

Aspect 40. A thermoplastic part or other article of manufacture according to any aspect described herein, wherein the draft angle is about 1°, about 0°, about −1°, or less.

Aspect 41. A thermoplastic part or other article of manufacture according to any aspect described herein, wherein the challenging microfeature comprises a recess having at least one lateral dimension of about 250 μm or less and at least one undercut.

Aspect 42. A thermoplastic part or other article of manufacture according to any aspect described herein, wherein the challenging microfeature comprises a protrusion having at least one lateral dimension of about 250 μm or less and at least one undercut.

Aspect 43. A thermoplastic part or other article of manufacture according to any aspect described herein, wherein the challenging microfeature comprises a recess having at least one lateral dimension of about 250 μm or less and at least one textured vertical surface.

Aspect 44. A thermoplastic part or other article of manufacture according to any aspect described herein, wherein the challenging microfeature comprises a protrusion having at least one lateral dimension of about 250 μm or less and at least one textured vertical surface.

Aspect 45. A thermoplastic part or other article of manufacture according to any aspect described herein, wherein the textured vertical surface comprises a threaded post, a scalloped wall, or similar textured vertical wall.

Aspect 46. A thermoplastic part or other article of manufacture according to any aspect described herein, wherein the textured vertical surface comprises a micron-scale texture selected from the group consisting of micron-scale grooves, micron-scale dimples, micron-scale texture, and a combination thereof.

Aspect 47. A thermoplastic part or other article of manufacture according to any aspect described herein, wherein the lateral dimension is about 200 μm, 150 μm, 100 μm, 50 μm, or less.

Aspect 48. A thermoplastic part or other article of manufacture according to any aspect described herein, comprising a first lateral dimension and a second lateral dimension perpendicular to the first lateral dimension, wherein the first lateral dimension and the second lateral dimension have dimensions of about 5 mm or 20 mm to about 1000 mm or 2000 mm; and a vertical dimension perpendicular to the first and second lateral dimensions, the vertical dimension having a dimension of about 100 μm or 500 μm to about 5000 μm or 10000 μm.

Aspect 49. A thermoplastic part or other article of manufacture according to any aspect described herein, comprising: a first challenging microfeature on a first face of the thermoplastic part; and a second challenging microfeature on a second face opposite the first face; wherein an x-y alignment between the first challenging microfeature and the second challenging microfeature is about 100 μm, about 80 μm, about 60 μm, about 40 μm, or less.

Aspect 50. A thermoplastic part or other article of manufacture according to any aspect described herein, wherein a thickness variation of the vertical dimension is about 10 μm/cm, about 5 μm/cm, or less.

Aspect 51. A thermoplastic part or other article of manufacture according to any aspect described herein, wherein the challenging microfeature comprises a smooth surface having a nanometer scale smoothness.

Aspect 52. A thermoplastic part or other article of manufacture according to any aspect described herein, comprising a macroscale feature; wherein a mean normalized displacement between the macroscale feature and the challenging microfeature is about 1%, about 0.5%, about 0.1% or less when measured between the part and the master.

Aspect 53. A thermoplastic part or other article of manufacture according to any aspect described herein, wherein the thermoplastic comprises polyethylene (PE), polypropylene (PP), poly(vinyl chloride) (PVC), polycarbonate (PC), polyethylene terephthalate (PET), cyclic olefin polymer (COP), cyclic olefin copolymer (COC), poly(methyl methacrylate) (PMMA), polyamides, polyimides, polyesters, polyurethanes, polyoxymethylene, thermoplastic fluoropolymers (e.g., ethylene tetrafluoroethylene (ETFE), perfluoroalkoxy alkanes (PFA), Polyvinylidene fluoride or polyvinylidene difluoride (PVDF), Fluorinated ethylene propylene (FEP), etc.), styrenic block copolymers (e.g., styrene butadiene styrene (SBS), styrene ethylene butylene styrene (SEBS), Styrene isoprene block copolymer (SIS), styrene isobutylene-bock-styrene (SIBS), etc.) or copolymers thereof and copolymers thereof with other polymers.

Aspect 54. A thermoplastic part or other article of manufacture according to any aspect described herein, comprising at least one macro-scale feature having at least one textured vertical surface.

### EXAMPLES: COMPARISON OF POSITIONAL ACCURACY IN THERMOPLASTIC PARTS MADE VIA HYBRID TOOLING AND THERMOPLASTIC PARTS MADE WITH CONVENTIONAL SOFT TOOLING

Methods

Thermoplastic parts were formed using both hybrid and soft tooling generated from the same microfabricated silicon insert. The parts have a multitude of recessed microfeatures, including microfluidic channels and microwells with lateral dimensions as small as 8 um and aspect ratios as high as 4:1. Due to the high aspect ratio of the microfeatures, these parts can only be formed and demolded using an elastomeric mold or a mold with an elastomeric surface. In addition to microfeatures, the parts include through-holes that are aligned to certain microfeatures, and a smooth vertical edge defining the rectangular perimeter of the part. For parts made by hybrid tooling, through hole and edge defining features are built into the mold. For part made soft tooling, these features are defined by CNC machining after the microstructures have been embossed. The parts were made from a high melt-flow cyclic olefin polymer, Zeonex COP 1430R, that was pre-formed into featureless rectangular blanks by injection molding.

Hybrid Tools and Embossing Parameters:

A thermoplastic forming assemblage consisting of one top and one bottom tool were fabricated as described in PCT/US2019/063338. The top and bottom tools were made of an aluminum rigid backing and an RTV silicone as the elastomeric layer. The micro-featured silicon insert was mounted in an acrylic frame to form the master structure for the top tool. Another acrylic master, with an optically smooth surface, was used to form the bottom tool which comprises a 25 mm×75 mm×1 mm cavity. The parts were formed from a COP 1430R blank, sized appropriately to match the volume of the mold cavity. The embossing temperature and pressure were 215° C. and 5 kN respectively. No post-processing of the part was required after embossing.

Conventional Soft Tools and Embossing Parameters:

The soft tools consisting of a fully elastomeric top and bottom tool were made using the method described in US Patent Application Publication 2004/0241049 by Carvalho. The micro-featured silicon insert was mounted in an acrylic frame to form the master structure for the top tool. Another acrylic master, with an optically smooth surface, was used to form the bottom tool with an oversized 50 mm×100 mm×1 mm cavity. Because soft tooling produces embossed parts with significant thickness variation and poorly defined edges, it is necessary to oversize the embossed part and cut out the central portion of the part in a separate processing step. The top and bottom elastomeric tools were formed by casting an RTV silicone between their respective master structure and a flat piece of glass. The parts were formed from a COP 1430R blank, sized appropriately to match the volume of the mold cavity. The embossing temperature and pressure were 225° C. and 5 kN respectively. An aluminum shim was used to laterally constrain the elastomeric tools to minimize deformation under compressive forces experienced during embossing. After embossing, the through holes and perimeter of the part were cut out on a CNC mill.

Characterization of Feature Positions:

Using an optical microscope with a motorized stage (with a repeatability of ˜1 um), the coordinates of a grid 16 microfeatures were measured on both parts and the silicon inserts from which they were replicated. The relative displacement of test part coordinates was compared to those of a reference structure, either another part or the silicon insert. In each case, a rigid translation and rotation were applied to the reference coordinates to minimize the sum of displacements between the test and reference coordinates.

Results

Simple Displacement (Part to Master Comparison):

Table 1 lists the mean and max displacements, the mean normalized displacement, and the maximum normalized displacement for the thermoplastic parts compared to the master structure (16 points each comparison). The displacements of the hybrid parts are dominated by a uniform shrinkage with respect to the master, while the soft tooling parts exhibit more complicated distortions. The terms “Hybrid 1”, “Hybrid 2”, and “Hybrid 3” refer to parts made via the hybrid tooling techniques provided herein. The terms “Soft 1” and “Soft 2” refer to analogous parts made via conventional soft tooling.

TABLE 1
Mean and Max Displacements(μm), Mean Normalized
Displacement (%), and Max Normalized
Displacement (%) for hybrid and soft tooling.

| | | | Normalized | |
|---|---|---|---|---|
| | Displacement (μm) | | displacement (%) | |
| | Mean | Max | Mean | Max |
| Hybrid 1 | 85 | 131 | 0.51 | 0.56 |
| Hybrid 2 | 88 | 137 | 0.53 | 0.59 |
| Hybrid 3 | 80 | 122 | 0.48 | 0.54 |
| Soft 1 | 109 | 209 | 0.73 | 1.4 |
| Soft 2 | 168 | 324 | 1.1 | 2 |

Isolate Non-Isotropic Contributions (Part to Master Comparison)

The isotropic shrinkage was removed via fitting with scaling factor A, and the displacement analysis was completed again. Isotropic scaling maps the hybrid coordinates nicely onto the master coordinates. Table 2 presents the results for the mean and max displacements, the mean normalized displacement, and the maximum normalized displacement for the thermoplastic parts compared to the master structure (16 points each comparison) after accounting for the isotropic shrinkage.

TABLE 2
Mean and Max Displacements(μm), Mean Normalized
Displacement (%), and Max Normalized Displacement
(%) for hybrid and soft tooling after removing isotropic scaling.

| | | | | Normalized | |
|---|---|---|---|---|---|
| | | Displacement | | displacement | |
| | A | Mean | Max | Mean | Max |
| Hybrid 1 | 0.9948 | 13 | 20 | 0.092 | 0.14 |
| Hybrid 2 | 0.9945 | 12 | 17 | 0.082 | 0.12 |
| Hybrid 3 | 0.9950 | 13 | 19 | 0.089 | 0.14 |
| Soft 1 | 1.0008 | 108 | 211 | 0.72 | 1.3 |
| Soft 2 | 0.9950 | 151 | 338 | 1.1 | 2.6 |

Account for 0.52% Isotropic Shrinkage

To demonstrate the contributions the choice of material has to a fixed isotropic shrinkage, the analysis proceeded by removing a constant 0.52% isotropic shrinkage prior to the comparison. Table 3 presents the results for the mean and max displacements, the mean normalized displacement, and the maximum normalized displacement for the thermoplastic parts compared to the master structure (16 points each comparison) after accounting for a constant 0.52% isotropic shrinkage. As can be seen, the results are nearly identical to those from Table 2.

TABLE 3
Mean and Max Displacements(μm), Mean Normalized
Displacement (%), and Max Normalized Displacement
(%) for hybrid and soft tooling after accounting
for a fixed 0.52% isotropic shrinkage.

| | | | | Normalized | |
|---|---|---|---|---|---|
| | Isotropic | Displacement | | displacement | |
| | scaling | Mean | Max | Mean | Max |
| Hybrid 1 | 0.9948 | 13 | 20 | 0.091 | 0.14 |
| Hybrid 2 | 0.9948 | 12 | 20 | 0.082 | 0.12 |
| Hybrid 3 | 0.9948 | 13 | 23 | 0.096 | 0.17 |
| Soft 1 | 0.9948 | 148 | 262 | 1 | 1.7 |
| Soft 2 | 0.9948 | 151 | 337 | 1.1 | 2.7 |

Part to Part Comparison

The mean normalized displacement was next compared between parts prepared from the same method as a measure of part-to-part variability. Table 4 presents the mean and maximum displacements (μm), the mean normalized displacement (%), and the maximum normalized displacement (%) between parts made via either hybrid tooling or soft tooling. The terminology to denote the measurement is the method (hybrid or soft) and the part numbers being compared, e.g. “hybrid 1-2” is a comparison over 16 points between the first hybrid part and the second hybrid part.

TABLE 4
Mean and Max Displacements(μm), Mean Normalized
Displacement (%), and Max Normalized Displacement
(%) for part-to part comparisons for hybrid and soft tooling.

| | | | Normalized | |
|---|---|---|---|---|
| | Displacement (μm) | | displacement (%) | |
| | Mean | Max | Mean | Max |
| Hybrid 1-2 | 4 | 7 | 0.028 | 0.064 |
| Hybrid 2-3 | 9 | 14 | 0.055 | 0.091 |
| Hybrid 1-3 | 6 | 10 | 0.038 | 0.084 |
| Soft 1-2 | 148 | 298 | 0.93 | 1.5 |

It should be emphasized that the above-described aspects of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A plurality of thermoplastic parts having precision micro-scale features and reproducible macro-scale dimensions;
wherein the precision micro-scale features on each part comprise at least one challenging microfeature; and
wherein a mean normalized displacement of the precision micro-scale features is about 0.1% or less when measured between the parts within a same produced batch of the plurality of thermoplastic parts.

2. A plurality of thermoplastic parts having precision micro-scale features and reproducible macro-scale dimensions;
wherein the precision micro-scale features on each part comprise at least one challenging microfeature; and
wherein a maximum normalized displacement of the precision micro-scale features is about 0.1% or less when measured between the parts within a same produced batch of the plurality of thermoplastic parts.

3. A plurality of thermoplastic parts having precision micro-scale features and reproducible macro-scale dimensions;
wherein the precision micro-scale features on each part comprise at least one challenging microfeature; and
wherein a maximum displacement between the precision micro-scale features is about 10 μm or less when measured between the parts within a same produced batch of the plurality of thermoplastic parts.

4. A plurality of thermoplastic parts having precision micro-scale features and reproducible macro-scale dimensions;
wherein the precision micro-scale features on each part comprise at least one challenging microfeature; and
wherein a mean displacement between the precision micro-scale features is about 10 μm or less when measured between the parts within a same produced batch of the plurality of thermoplastic parts.

5. The plurality of thermoplastic parts according to claim 1, comprising two, three, or four of the following:
(i) wherein a mean normalized displacement of the precision micro-scale features is about 0.1%, 0.07%, 0.06%, or less when measured between the parts within a same produced batch of the plurality of thermoplastic parts;
(ii) wherein a maximum normalized displacement of the precision micro-scale features is about 0.5%, 0.2%, 0.1% or less when measured between the parts within a same produced batch of the plurality of thermoplastic parts;
(iii) wherein a maximum displacement between the precision micro-scale features is about 100 μm, 50 μm, 10 μm or less when measured between the parts within a same produced batch of the plurality of thermoplastic parts; and
(iv) wherein a mean displacement between the precision micro-scale features is about 100 μm, 50 μm, 10 μm or less when measured between the parts within a same produced batch of the plurality of thermoplastic parts.

6. The plurality of thermoplastic parts according to claim 1, wherein the at least one challenging microfeature comprises a recess having at least one lateral dimension of about 250 μm or less and an aspect ratio (height:width) of at least 2:1.

7. The plurality of thermoplastic parts according to claim 1, wherein the at least one challenging microfeature comprises a protrusion having at least one lateral dimension of about 250 μm or less and an aspect ratio (height:width) of at least 2:1.

8. The plurality of thermoplastic parts according to claim 1, wherein the at least one challenging microfeature comprises a post having at least one lateral dimension of about 250 μm or less and an aspect ratio (height:width) of at least 2:1.

9. The plurality of thermoplastic parts according to claim 1, wherein the at least one challenging microfeature comprises a well having at least one lateral dimension of about 250 μm or less and an aspect ratio (height:width) of at least 2:1.

10. The plurality of thermoplastic parts according to claim 1, wherein the at least one challenging microfeature comprises a channel or ridge having at least one lateral dimension of about 250 μm or less and an aspect ratio (height:width) of at least 2:1.

11. The plurality of thermoplastic parts according to claim 6, wherein the aspect ratio is about 2:1 to about 100:1, about 2:1 to about 50:1, about 2:1 to about 20:1, about 5:1 to about 20:1, about 5:1 to about 50:1, about 10:1 to about 20:1, or greater.

12. The plurality of thermoplastic parts according to claim 1, wherein the at least one challenging microfeature comprises a recess having at least one lateral dimension of about 250 μm or less and a vertical wall with a draft angle of about 2° or less.

13. The plurality of thermoplastic parts according to claim 1, wherein the at least one challenging microfeature comprises a protrusion having at least one lateral dimension of about 250 μm or less and a vertical wall with a draft angle of about 2° or less.

14. The plurality of thermoplastic parts according to claim 12, wherein the draft angle is about 1°, about 0°, about −1°, or less.

15. The plurality of thermoplastic parts according to claim 1, wherein the at least one challenging microfeature comprises a recess having at least one lateral dimension of about 250 μm or less and at least one undercut.

16. The plurality of thermoplastic parts according to claim 1, wherein the at least one challenging microfeature comprises a protrusion having at least one lateral dimension of about 250 μm or less and at least one undercut.

17. The plurality of thermoplastic parts according to claim 1, wherein the at least one challenging microfeature comprises a recess having at least one lateral dimension of about 250 μm or less and at least one textured vertical surface.

18. The plurality of thermoplastic parts according to claim 1, wherein the at least one challenging microfeature comprises a protrusion having at least one lateral dimension of about 250 μm or less and at least one textured vertical surface.

19. The plurality of thermoplastic parts according to claim 17, wherein the at least one textured vertical surface comprises a threaded post, a scalloped wall, or similar textured vertical wall.

20. The plurality of thermoplastic parts according to claim 17, wherein the at least one textured vertical surface comprises a micron-scale texture selected from the group consisting of micron-scale grooves, micron-scale dimples, micron-scale texture, and a combination thereof.

21. The plurality of thermoplastic parts according to claim 6, wherein the at least one lateral dimension is about 200 μm, 150 μm, 100 μm, 50 μm, or less.

22. The plurality of thermoplastic parts according to claim 1, wherein each of the thermoplastic parts in the plurality of thermoplastic parts comprises:
a first lateral dimension and a second lateral dimension perpendicular to the first lateral dimension, wherein the first lateral dimension and the second lateral dimension have magnitudes of about 5 mm or 20 mm to about 1000 mm or 2000 mm; and
a vertical dimension perpendicular to the first and second lateral dimensions, the vertical dimension having a magnitude of about 100 μm or 500 μm to about 5000 μm or 10000 μm.

23. The plurality of thermoplastic parts according to claim 1, wherein each of the thermoplastic parts in the plurality of thermoplastic parts comprises:
a first challenging microfeature on a first face of the thermoplastic part; and
a second challenging microfeature on a second face opposite the first face;
wherein an x-y alignment between the first challenging microfeature and the second challenging microfeature is about 100 μm, about 80 μm, about 60 μm, about 40 μm, or less.

24. The plurality of thermoplastic parts according to claim 22, wherein a thickness variation of the vertical dimension is about 10 μm/cm, about 5 μm/cm, or less.

25. The plurality of thermoplastic parts according to claim 1, wherein the challenging microfeature comprises a smooth surface having a nanometer scale smoothness.

26. The plurality of thermoplastic parts according to claim 1, wherein each of the thermoplastic parts in the plurality of thermoplastic parts comprises a macroscale feature;
wherein a mean normalized displacement between the macroscale feature and the challenging microfeature is about 1%, about 0.5%, about 0.1% or less when measured between each of the parts within a same produced batch of the plurality of parts.

27. The plurality of thermoplastic parts according to claim 26, wherein the thermoplastic comprises polyethylene (PE), polypropylene (PP), poly(vinyl chloride) (PVC), polycarbonate (PC), polyethylene terephthalate (PET), cyclic olefin polymer (COP), cyclic olefin copolymer (COC), poly(methyl methacrylate) (PMMA), polyamides, polyimides, polyesters, polyurethanes, polyoxymethylene, thermoplastic fluoropolymers (e.g., ethylene tetrafluoroethylene (ETFE), perfluoroalkoxy alkanes (PFA), polyvinylidene fluoride or polyvinylidene difluoride (PVDF), fluorinated ethylene propylene (FEP), etc.), styrenic block copolymers (e.g., styrene butadiene styrene (SBS), styrene ethylene butylene styrene (SEBS), Styrene isoprene block copolymer (SIS), styrene isobutylene-block-styrene (SIBS), etc.) or copolymers thereof and copolymers thereof with other polymers.

28. The plurality of thermoplastic parts according to claim 26, wherein each of the parts in the plurality of parts comprise at least one macro-scale feature having at least one textured vertical surface.

29. A thermoplastic part having precision micro-scale features and reproducible macro-scale dimensions;
wherein the precision micro-scale features comprise at least one challenging microfeature; and
wherein a mean normalized contribution to the non-isotropic displacement between the precision micro-scale features is about 0.1% or less when measured between the thermoplastic part and an idealized master part.

30. The thermoplastic part according to claim 29, wherein the mean normalized contribution to the non-isotropic displacement is computed by subtracting the isotropic distortion relative to the idealized master part prior to measuring the displacement.

31. The thermoplastic part according to claim 29, wherein the mean normalized contribution to the non-isotropic displacement is computed by subtracting a static amount of isotropic shrinkage prior to measuring the non-isotropic displacement, wherein the static amount of isotropic shrinkage is a percentage based upon a composition of the thermoplastic.

32. The thermoplastic part according to claim 29, wherein the at least one challenging microfeature comprises a recess having at least one lateral dimension of about 250 μm or less and an aspect ratio (height:width) of at least 2:1.

33. The thermoplastic part according to claim 29, wherein the at least one challenging microfeature comprises a protrusion having at least one lateral dimension of about 250 μm or less and an aspect ratio (height:width) of at least 2:1.

34. The thermoplastic part according to claim 29, wherein the at least one challenging microfeature comprises a post having at least one lateral dimension of about 250 μm or less and an aspect ratio (height:width) of at least 2:1.

35. The thermoplastic part according to claim 29, wherein the at least one challenging microfeature comprises a well having at least one lateral dimension of about 250 μm or less and an aspect ratio (height:width) of at least 2:1.

36. The thermoplastic part according to claim 29, wherein the at least one challenging microfeature comprises a channel or ridge having at least one lateral dimension of about 250 μm or less and an aspect ratio (height:width) of at least 2:1.

37. The thermoplastic part according to claim 32, wherein the aspect ratio is about 2:1 to about 100:1, about 2:1 to about 50:1, about 2:1 to about 20:1, about 5:1 to about 20:1, about 5:1 to about 50:1, about 10:1 to about 20:1, or greater.

38. The thermoplastic part according to claim 29, wherein the at least one challenging microfeature comprises a recess having at least one lateral dimension of about 250 μm or less and a vertical wall with a draft angle of about 2° or less.

39. The thermoplastic part according to claim 29, wherein the at least one challenging microfeature comprises a protrusion having at least one lateral dimension of about 250 μm or less and a vertical wall with a draft angle of about 2° or less.

40. The thermoplastic part according to claim 38, wherein the draft angle is about 1°, about 0°, about −1°, or less.

41. The thermoplastic part according to claim 29, wherein the at least one challenging microfeature comprises a recess having at least one lateral dimension of about 250 μm or less and at least one undercut.

42. The thermoplastic part according to claim 29, wherein the at least one challenging microfeature comprises a protrusion having at least one lateral dimension of about 250 μm or less and at least one undercut.

43. The thermoplastic part according to claim 29, wherein the at least one challenging microfeature comprises a recess having at least one lateral dimension of about 250 μm or less and at least one textured vertical surface.

44. The thermoplastic part according to claim 29, wherein the at least one challenging microfeature comprises a protrusion having at least one lateral dimension of about 250 μm or less and at least one textured vertical surface.

45. The thermoplastic part according to claim 43, wherein the at least one textured vertical surface comprises a threaded post, a scalloped wall, or similar textured vertical wall.

46. The thermoplastic part according to claim 43, wherein the at least one textured vertical surface comprises a micron-scale texture selected from the group consisting of micron-scale grooves, micron-scale dimples, micron-scale texture, and a combination thereof.

47. The thermoplastic part according to claim 32, wherein the lateral dimension is about 200 μm, 150 μm, 100 μm, 50 μm, or less.

48. The thermoplastic part according to claim 29, comprising
a first lateral dimension and a second lateral dimension perpendicular to the first lateral dimension, wherein the first lateral dimension and the second lateral dimension have magnitudes of about 5 mm or 20 mm to about 1000 mm or 2000 mm; and
a vertical dimension perpendicular to the first and second lateral dimensions, the vertical dimension having a magnitude of about 100 μm or 500 μm and up to about 5000 μm, 10000 μm, or 50000 μm.

49. The thermoplastic part according to claim 29, comprising:
a first challenging microfeature on a first face of the thermoplastic part; and
a second challenging microfeature on a second face opposite the first face;
wherein an x-y alignment between the first challenging microfeature and the second challenging microfeature is about 100 μm, about 80 μm, about 60 μm, about 40 μm, or less.

50. The thermoplastic part according to claim 48, wherein a thickness variation of the vertical dimension is about 10 μm/cm, about 5 μm/cm, or less.

51. The thermoplastic part according to claim 29, wherein the challenging microfeature comprises a smooth surface having a nanometer scale smoothness.

52. The thermoplastic part according to claim 29, comprising a macroscale feature;
wherein a mean normalized displacement between the macroscale feature and the challenging microfeature is about 1%, about 0.5%, about 0.1% or less when measured between the part and the master.

53. The thermoplastic part according to claim 29, wherein the thermoplastic comprises polyethylene (PE), polypropylene (PP), poly(vinyl chloride) (PVC), polycarbonate (PC), polyethylene terephthalate (PET), cyclic olefin polymer (COP), cyclic olefin copolymer (COC), poly(methyl methacrylate) (PMMA), polyamides, polyimides, polyesters, polyurethanes, polyoxymethylene, thermoplastic fluoropolymers (e.g., ethylene tetrafluoroethylene (ETFE), perfluoroalkoxy alkanes (PFA), Polyvinylidene fluoride or polyvinylidene difluoride (PVDF), Fluorinated ethylene propylene (FEP), etc.), styrenic block copolymers (e.g., styrene butadiene styrene (SBS), styrene ethylene butylene styrene (SEBS), Styrene isoprene block copolymer (SIS), styrene isobutylene-block-styrene (SIBS), etc.) or copolymers thereof and copolymers thereof with other polymers.

54. The thermoplastic part according to claim 29, comprising at least one macro-scale feature having at least one textured vertical surface.
